(19) United States
(12) Patent Application Publication
(10) Pub. No.: US 2005/0109175 A1
(43) Pub. Date: May 26, 2005

(54) Spindle liner for lathes and turning machines

(76) Inventor: Tymen Clay, Stratford (CA)

Correspondence Address: Thomas N. Young, Suite 624, 3001 West Big Beaver Road, Troy, MI, 48084, US

(21) Appl. No.: 10/722,625

(22) Filed: Nov. 26, 2003

(51) Int. Cl. B23B 13/00

(52) U.S. Cl. 82/127

(57) ABSTRACT

A spindle liner for use with in a spindle of a lathe or turning machine for supporting stock to be worked including a plurality of tube sections having a diameter selected to permit these sections to be placed end to end within the spindle. Each tube section has a passageway extending the length thereof and has threaded male and female connectors at opposite ends. The liner includes a plurality of tube inserts, each of which can be mounted within the tube passageway of a respective one of the tube sections. Each insert defines an axial passageway through which the stock to be worked can pass in a close filling manner. The tube sections and inserts are constructed so that the inserts are kept in a desired spaced-apart relationship in the liner.

### BACKGROUND OF THE INVENTION

This invention relates to spindle liners for use within a spindle of a lathe or turning machine in order to support stock to be worked by the lathe or turning machine.

Spindle liners, which are well known in the machining and automated tooling industries, are currently used to keep bar stock on centre in the spindle of a lathe. Spindle liners which can also be called filler tubes or reduction tubes, are used to reduce the internal diameter of the passageway that extends through the lathe spindle. It is known, for example, for such liners to reduce the internal diameter to between 0.03 to 0.06 over the diameter of the bar stock being machined. The use of a spindle liner can reduce the vibration that can otherwise result from an imbalance of having a bar flopping around in the spindle as the lathe is operated. A second advantage arising from the use of a spindle liner is that this use can ensure that the push rod used to feed the bar stock will stay centered on the bar stock. Spindle liners have been used with bar feeders, bar loaders and bar pullers. Both metal and non-metal spindle liners are known for use with lathe machines. For example, it is known to provide polyurethane spindle liners for CNC lathes. These non-metal liners are lighter than conventional metal liners and the inner bore can be molded to the shape and size of the bar being fed through the spindle.

U.S. Pat. No. 5,927,169 issued Jul. 27, 1999 to R. L. Hinson, describes a draw tube adaptor for insertion into the draw tube of a lathe. This adaptor includes a sleeve and a series of bushings mounted within the sleeve and spaced-apart from one another. The bushings have bores sized to accommodate the diameter of the stock to be worked and they are maintained in their spaced-apart relationship by cylindrical spacers carried within the sleeve. A cap is provided on the sleeve to retain the spacers and bushings within the sleeve.

Very recent U.S. Pat. No. 6,575,063 which issued Jun. 10, 2003 to T. Inaba, teaches a bar supporting apparatus for use in conjunction with an automatic lathe, this apparatus preventing the rotating bar held by the chuck of the main spindle of the lathe from oscillating. This known apparatus includes a cylindrical, elongate case and arc-shaped fixing members attached to the external surface of the case at spaced-apart locations along the length of the case. Arc-shaped supports for the bar stock are attached to the fixing members and they are mounted in pairs on opposite sides of the case so as to extend through holes formed in opposite sides of the case. The construction of this known bar supporting apparatus is fairly complex and it requires the use of three different components which must be carefully fitted together and attached.

It is an object of the present invention to provide a unique spindle liner for use within a spindle of a lathe or turning machine, which spindle liner can be manufactured at a reasonable cost and which is relatively easy to assemble and use.

It is a further object of the present invention to provide an improved spindle liner comprising a plurality of tube sections and tube inserts wherein the tube inserts can readily be changed or modified, if required.

### SUMMARY OF THE INVENTION

According to one aspect of the invention, a spindle liner for insertion into a draw tube of a lathe or other turning machine for supporting stock to be worked by the lathe or turning machine includes a plurality of tube sections, each having a principal external diameter selected to permit the tube sections to be placed end-to-end in the draw tube and corresponding closely to an internal diameter of the draw tube. Each tube section has a tube passageway extending the length of the tube section, a male connector at one end thereof, and a female connector at an opposite end thereof adapted to connect to the male connector of an adjacent tube section. There are also a plurality of tube inserts, each adapted to be mounted within the tube passageway of a respective one of the tube sections adjacent the opposite end of the respective tube section. Each of these tube inserts defines an axial bore therein through which the stock to be worked can pass in a close fitting manner. During use of the liner, the tube inserts are kept in a desired, spaced apart relationship by the tubes sections.

In a preferred embodiment, the male connector is externally threaded and has an outer diameter that is smaller than the principal external diameter of the tube section. The female connector is internally threaded with threads matching those on the male connector.

According to another aspect of the invention, a spindle liner for mounting inside a spindle of a lathe or turning machine for supporting stock to be worked by the lathe or turning machine includes a plurality of tube sections, each having a main longitudinal portion with a selected external diameter suitable for insertion of each tube section into a feed passageway formed in the spindle so as to permit the tube sections to be placed substantially end-to-end in the spindle. Each tube section defines a tube passageway extending the length of the tube section. The tube sections include connectors for joining the tube sections together in a substantially end-to-end manner. There are also a plurality of tube inserts each adapted to be mounted within the tube passageway of a respective one of the tube sections. Each tube insert defines an axial insert passageway therein through which the stock to be worked can pass in a close fitting manner. During use of this liner, the tube inserts are kept in a desired spaced-apart relationship by the tube sections.

In a preferred version of this spindle liner, the connectors include male and female integral connecting sections on opposite ends of each tube section. The male connecting section is externally threaded and the female connecting section is internally threaded with threads matching the threads of the male connecting section.

According to still another aspect of the invention, a spindle liner for use in a lathe system for supporting bar stock to be worked by the lathe system includes a plurality of tube sections each having a substantially cylindrical main section with the selected external diameter suitable for insertion of each tube section into a feed passageway for the bar stock provided in the lathe system. Each tube section has a first integral connector projecting axially from one end of the cylindrical section while the opposite end of the cylindrical section has a second connector so as to be detachably connectable to the first connector of an adjacent one of the tube sections. Each tube section has a tube passageway extending the length of the cylindrical section and the first connector. The liner also has a plurality of tube inserts, each adapted to be mounted within the tube passageway of a respective one of the tube sections. Each of the tube inserts forms a central axial insert passageway through which the bar stock to be worked can pass in a close fitting manner. The spindle liner includes means for maintaining the tube inserts in a desired spaced-apart relationship relative to one another when the spindle liner is assembled and ready for use in the lathe system.

Preferably the first integral connector has external threads and the second connector comprises internal threads formed within the cylindrical main section.

Further features and advantages will become apparent from the following detailed description of a preferred embodiment taken in conjunction with the accompanying drawings.

### BRIEF DESCRIPTION OF THE DRAWINGS

FIG. 1 is a schematic, orthographic axial cross-section illustrating a prior art spindle liner mounted in a known lathe arrangement;

FIG. 2 is another orthographic, axial cross-section showing schematically another form of known spindle liner mounted in a lathe spindle;

FIG. 3 is an orthographic, schematic view of a spindle liner constructed in accordance with the invention with bar stock extending from one end;

FIG. 4 is an axial cross-section of the spindle liner of FIG. 3 with a section fo bar stock extending from the left end;

FIG. 5 is a side view of the spindle liner showing internal walls in dash lines;

FIG. 6 is a detail view of the circled section of the spindle liner of FIG. 5;

FIG. 7 is an end view of a bushing or tube insert used in the spindle liner of FIG. 4;

FIG. 8 is a side view of the bushing of FIG. 7;

FIG. 9 is an end view of a tube section used to construct the spindle liner;

FIG. 10 is a side view of an end portion of the tube section of the invention;

FIG. 11 is a side view of the complete tube section of FIGS. 9 and 10;

FIG. 12 is a side view of a-second version of the tube section of the spindle liner with a central portion omitted for ease of illustration;

FIG. 13 is a side view of a second version of the tube insert for use with the tube section of FIG. 12;

FIG. 14 is another side view of the second version of the tube insert, this figure showing the insert with an insert passageway of larger diameter;

FIG. 15 is a further side view of the tube insert, this figure showing the insert with an insert passageway of maximum diameter; and

FIG. 16 is an orthographic view of a spindle liner of the invention fitted with an optional stop flange member.

### DETAILED DESCRIPTION OF PREFERRED EMBODIMENTS

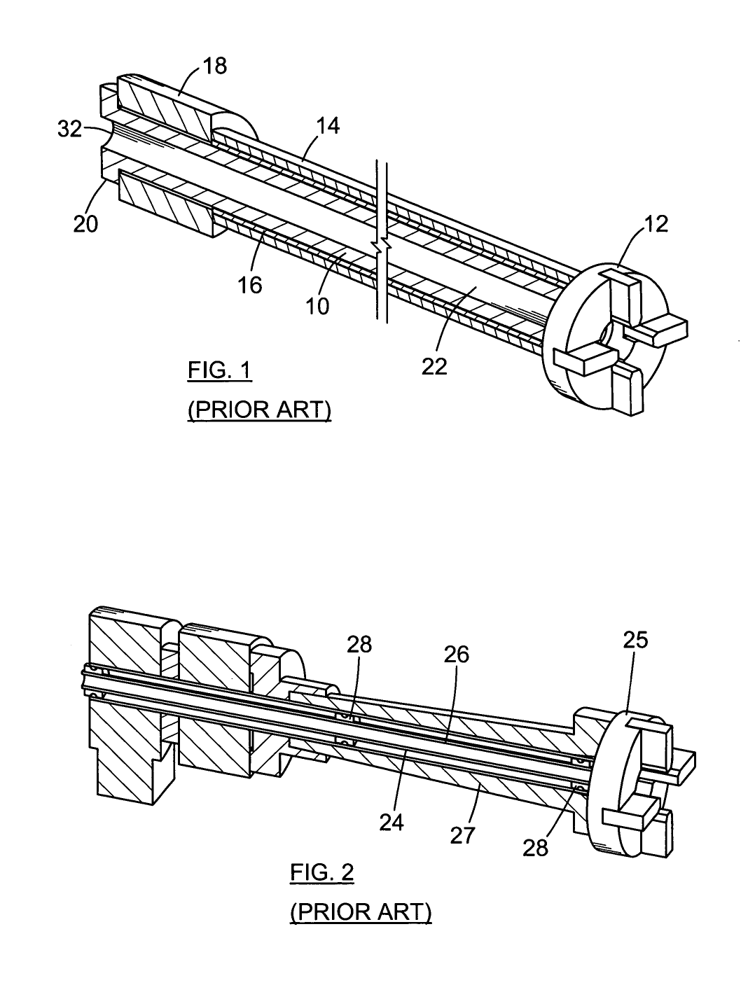

FIG. 1 illustrates schematically a prior art lathe arrangement and illustrates the known use of a spindle liner 10. On the right side of the figure is a standard lathe chuck 12 which is used to hold an end section of a bar stock (not shown in FIG. 1) firmly as the chuck rotates. It will be appreciated that the speed of rotation of the chuck can be quite high for many machining operations, for example, in excess of 1,000 rpm. Extending from one side of the chuck and connected thereto by bolts is a lathe spindle 14 which rotates the chuck and thus acts as a form of drive shaft. In a known manner, this spindle 14 is supported by bearings (not shown) located on the exterior of the spindle. In one known CNC lathe, the spindle is supported by lubricated, tapered roller bearings so that there is no play as the elongate spindle rotates. Located on the inside of the spindle is a draw tube 16 which is used to operate the chuck and which can be moved a short distance in the axial direction by means of an actuator 18 which can be operated either hydraulically or pneumatically. It will also be understood that the spindle is rotated at the required speed for lathe operation by means of a motor of the lathe, this motor not being shown in FIG. 1. In some lathes there is no draw tube and the chuck is operated by a different type of actuator.

If the bar stock to be worked in the lathe (which bar stock can be in the form of solid, elongate bars or tubes) has an outer diameter or has transverse dimensions which are significantly less than the internal diameter of the draw tube, it is generally necessary to insert a spindle liner 10 inside the draw tube. The illustrated prior art draw tube 10 of FIG. 1 has a generally uniform outside diameter which corresponds closely to the internal diameter of the draw tube. The illustrated spindle liner has an end flange 20 which acts to hold the spindle liner in the correct position but it will be understood that an end flange is not always necessary and is not required with some spindle liners, including spindle liners constructed in accordance with the present invention. Extending the length of the spindle liner is a bar stock passageway 22 whose transverse cross-section is sized to fit the bar stock that is to be machined with the spindle liner closely, thereby preventing undesirable vibration or oscillation of the bar stock during operation of the lathe. Generally the closer the fit between the external transverse dimensions of the bar stock and the transverse cross-sectional dimensions of the passage 22 the better from the standpoint of the lathing operation. However, it is also generally desirable that the external cross-sectional dimension of the passageway 22 is preferably slightly greater than the transverse dimensions of the bar stock in order to permit the bar stock to be fed relatively easily through the passageway during operation of the lathe. It is believed that a spindle liner currently is needed for use in conjunction with an automated lathe or CNC lathe for every size bar to be machined in increments of 1/32 to ⅛^{th} inch depending on the precision required. The external dimension of the spindle liner is generally dictated by the internal diameter of the draw tube or spindle into which the spindle liner must fit reasonably snugly and known spindle liners vary widely in their external dimensions. For example, the spindle liner size can vary from less than one inch outside diameter up to six inches and larger. Typical spindle liners are made from metal but it is also known in the art to make these liners from suitable plastics such as polyurethane.

Illustrated in FIG. 2 is an alternative form of known spindle liner. This known spindle liner 24 can be made from a single elongate metal tube 26 and fitted on the spindle liner are three or more metal collars 28 which act as evenly distributed spacers between the tube 26 and the inside of the draw tube or spindle. Also shown in FIG. 2 is a lathe chuck 25 and a spindle 27 which is connected to the chuck in order to drive same.

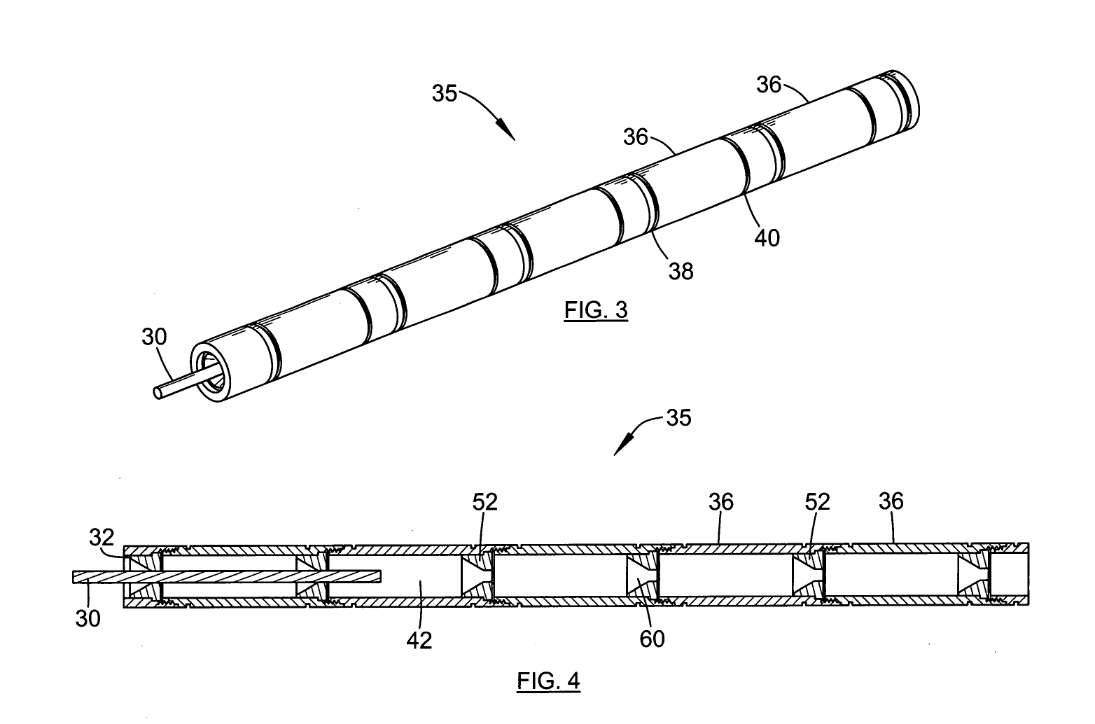

A section of sample bar stock is shown at 30 in FIGS. 3 and 4. As is well known in the lathing industry, the bar stock is either pushed or pulled through the passageway 22 in the spindle liner by bar feeding equipment. The bar stock is fed into the passageway from the left end 32 (as shown in FIG. 4) and it is pushed or pulled through the spindle liner until it projects into and through the chuck 12 or 25. The lathe is then operated and the projecting end section of the bar stock is machined as required and then the machine end piece can be cut off using a suitable metal cutter (not shown) located next to the chuck. After each required part is produced, the bar stock is then again pushed or pulled through the passageway 22 the required distance for the next machining and cutting operation. The present invention relates solely to the construction of the spindle liner which can be used in a similar manner to the illustrated prior art spindle liners.

A principal advantage of a spindle liner is that it can reduce the amount of vibration that can otherwise exist when the bar stock is rotated in the lathe, particularly at a high rate of speed. If the bar stock is not properly restrained in the spindle, the bar stock can tend to revolve or in some cases “orbit” about the free end of the draw tube, resulting in severe production and safety problems.

In order to avoid the aforementioned problem, spindle liners having inner diameters closely matching the stock to be worked are provided as inserts for the draw tube. The spindle liners have an inner diameter which is less than that of the draw tube found on the machine and this permits smaller diameter stock to be machined in the lathe. However, in the past, the use of such spindle liners has been costly when the user needs to machine a large variety of stock having many different diameters. Under such circumstances, a large number of spindle liners may be required in order to machine the various stock having a large number of different diameters.

Another advantage of a spindle liner is that it can ensure that the push rod, which can be used to feed the bar stock, stays centered on the bar stock. Also, in the case of certain automatically loaded lathes, the spindle liner can assist the reloading cycle. As a new bar is loaded into the lathe automatically, the spindle liner holds it aligned with the collette opening of the chuck. With out the proper spindle liner, the bar stock can jam against the inside of the collette.

Turning to FIGS. 3 and 4, they illustrate a complete spindle liner 35 constructed in accordance with the invention. For ease of understanding, a short section of bar stock 30 is shown extending into one end of the liner but, during use of the spindle liner, an elongate section of bar stock extends completely through the spindle liner and projects from one end the required distance for the machining operation. The illustrated first embodiment of a spindle liner comprises a plurality of tube sections 36, each having a principal external diameter D (see FIG. 6) selected to permit the tube sections to be placed substantially end-to-end in the draw tube and corresponding closely to an internal diameter of the draw tube 16. In the preferred embodiment shown in each of FIGS. 3 to 5, there are five of these tube sections 36 but it will be appreciated that there could be more or fewer of these sections depending on the length of the spindle liner required for a particular lathe or automatic lathe. The length of each tube section 36 is typically in the range of 6 to 10 inches but they can also be quite short, for example, only three inches. One or more short tube sections can be provided for use at the end of the spindle liner in order to adjust its overall length to the length of the draw tube or spindle in which it is to be used. The tube sections can be made of a variety of metals or they can be made from a strong, rigid plastics material. In a particularly preferred embodiment, the tube sections are made of tough, wear resistant nylon. Possible metals for the tube sections include steel or aluminum and the metal can be a hardened metal if desired or required by the particular machining operation.

Extending about the exterior of each tube section is at least one annular groove 38 and an O-ring 39 indicated in dash lines in FIG. 10 can be mounted in each annular groove 38 and projects a short distance therefrom. Each O-ring is made from a resilient, flexible sealing material, typically a rubber or rubber-like plastic material. In the preferred illustrated embodiment there are two annular grooves 38, 40 formed around each tube section near opposite ends of the respective tube section with an O-ring 39 fitted into each of these grooves. As illustrated in FIG. 11, the groove 38 is closer to one end 41 of the substantially cylindrical main section 43 of the tube section. The other groove 40 is preferably positioned further from its corresponding end 45 of the cylindrical main section 43. In this way, the groove 40 is formed in a portion of the tube section where the cylindrical wall of the tube section has not otherwise been reduced in its thickness. Thus, the structural integrity of the tube section is not substantially affected by the presence of the grooves. The use of and size of the O-rings 39 allow the assembled spindle liner to be inserted in a snug fitting manner into the draw tube 16 where it is held in place by a friction fit. Extending through each tube section is a tube passageway 42 and this tube passageway extends the entire length of the tube section including both the cylindrical main section 43 and the length of a male connector or end section 44 located at one end 41 of the tube section. The male connector 44 can be an integral extension of the main section 43 and it is preferably externally threaded at 49. Preferably the threads terminate a short distance, ie. 0.12 inch, from the end 41. Preferably the tube passageway 42 has a circular transverse cross-section as shown in FIG. 9.

Each tube section also has a female connector at the opposite end 45 adapted to connect to the male connector 44 of an adjacent tube section. A female connector is formed inside the tube section by means of internal threads 48, these threads matching the threads on the male connector 44. The internal threads are formed in an annular end cavity 50 which is a portion of the tube passageway of increased diameter. In other words, the annular cavity 50 has a slightly greater diameter than the main portion of the passageway 42, For example, in one embodiment, the main passageway has a diameter of about two inches while the annular end cavity 50 has a diameter of 2.25 inches approximately. It will be appreciated that the axial depth of the cavity 50 is greater than the length of the male connector 44 so that with a male connector fully threaded into the end cavity 50, there is still a short section 53 of the cavity which is not filled by the male connector. The purpose of this short section is explained below.

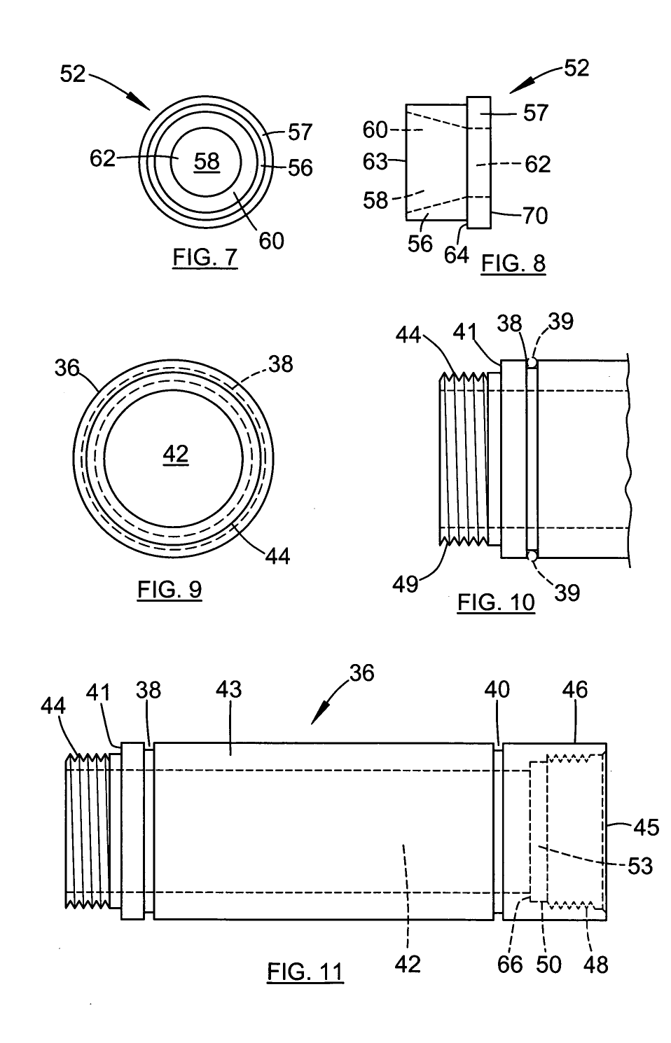

The other main component used to make the spindle liner 35 is a tube insert or bushing 52, one version of which is shown separately in FIGS. 7 and 8. A plurality of these tube inserts are used to assemble each spindle liner. The illustrated first version of the tube insert has a first axially extending section 56 and a second axially extending section 57 with the first section having a smaller external diameter than the second section. Both sections have a circular, transverse cross-section in the preferred embodiment. Extending through the tube insert is an axial bore or passageway 58 through which the stock to be worked can pass in a close fitting manner. In other words, the minimum diameter of the passageway 58 should be just slightly greater than the diameter of the bar stock in order to minimize vibrations of the bar stock during use of the lathe. Preferably, the passageway or bore 58 comprises a first portion 60 which tapers inwardly from an end 63 of the insert over the axial length of the first section. The passageway 58 also has a second portion 62 of uniform diameter with this second section being located in the section 57 of the insert. In this preferred insert, it is the diameter of the second portion 62 which is slightly greater than the diameter of the bar stock to be worked.

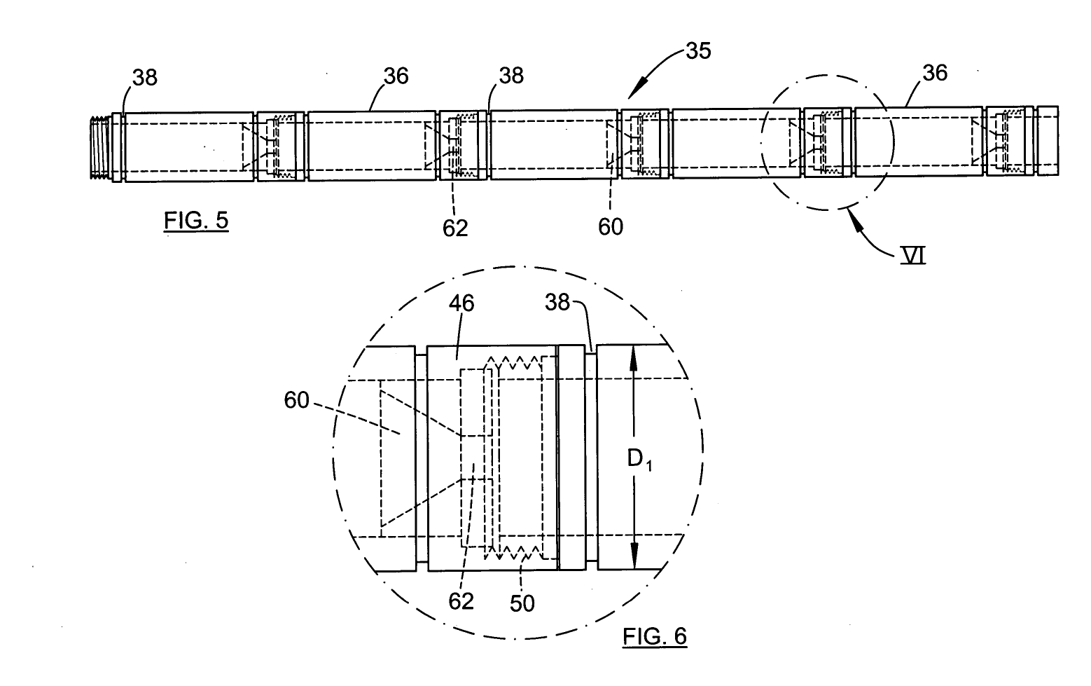

As shown in FIGS. 4 and 5, one of the tube inserts is mounted within the tube passageway of a respective one of the tubes sections 36 adjacent the opposite end 45 of the respective tube section. This particular tube insert is mounted so that the narrower first axially extending section 56 extends into the narrower main portion of the passageway 42. On the other hand, the wider second section 62 is positioned within the short section 53 of the end cavity 50. In fact, the bushing or tube insert is pushed into the tube section 36 until its external annular shoulder 64 rests against an internal annular shoulder 66. The shoulder 66 is formed within the tube section at the inner end of the end cavity 50. Once each tube insert is placed in this position so that it cannot move further into its respective tube section, the threaded male connector 44 of another tube section can be threaded into the end cavity 50 until it rests firmly against the wide end of the tube insert, thereby holding it firmly in place in its respective tube section. Thus, during use of the spindle liner, the tube inserts are kept in a desired, spaced apart relationship by the tube sections 36.

It will be understood that the purpose of the tapered first section 60 of the insert passageway is to help feed the bar stock through the tube insert and to center the end of the bar stock in the passageway as it is pushed or pulled through the spindle liner.

Like the tube sections, the tube inserts can also be made from a variety of rigid materials including metal or a suitable strong, rigid plastics material. In one particularly preferred embodiment of the spindle liner, both the tube sections and the tube inserts are molded and are made of nylon. Another possible material for the tube inserts is wood.

During use of the spindle liner, the tube inserts 52 are selected which have a minimum inner diameter in the second portion 62 which substantially matches, or is slightly larger than, the outer diameter of the stock to be worked. If the inner diameter of the inserts is too small to handle the stock, it is possible to drill the insert passageway to the correct, desired diameter. Alternatively, if the diameter of the second portion 62 of the insert is too large for the stock, additional tube inserts can be chosen or obtained at a relatively low cost and, if necessary, these inserts can be drilled to fit the stock to be worked. Once tube inserts having the correct inner diameter have been obtained or made, each of them is then inserted into its respective tube section and then the tube sections are connected to each other in an end-to-end manner. The assembled spindle liner can then be inserted into the draw tube for use.

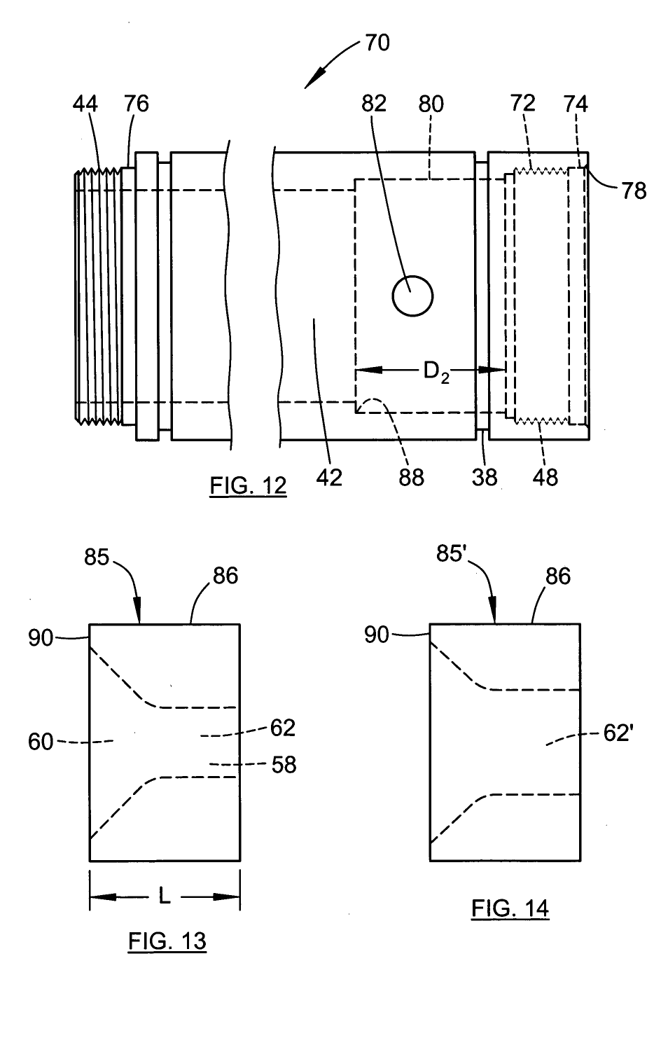

FIG. 12 illustrates a second embodiment of tube section 70 which can also be used to construct a spindle liner in accordance with the present invention. This tube section 70 is similar in its construction to the above described tube section 36 except for the differences noted hereinafter. The tube section 70 can also be provided with one or more annular grooves 38 like those in the first embodiment, with each groove been fitted with an O-ring 39. The tube section 70 also has a male connector 44 at one end with external threads extending about this male connector. Also, a female connector 72 is provided at the opposite end and this connector has internal threads 48. In a particularly preferred embodiment, there is a short annular wall section 74 which is not threaded, this wall section being provided to accommodate an unthreaded portion 76 of the male connector. For ease of insertion of the adjacent male connector 44, a small chamfer 78 can be provided next to the wall section 74.

The tube section 70 has an enlarged annular cavity 80 which is an extension of or part of the passageway 42 that extends through the tube section. The cavity 80 has a slightly greater diameter than the remaining portion of the passageway 42. The cavity 80 is enlarged as compared to the annular cavity 50 in the first embodiment in that it has a relatively greater axial length. The reason for this is that the axial distance D₂ of the cavity 80 is provided to accommodate the full length of a tube insert 85 that is used with this form of tube section. This second form of tube insert is illustrated in FIGS. 13 to 15 of the drawings. In one embodiment of a tube section 70 constructed in accordance with the invention, the distance D₂ measured 1.425 inch while the outside diameter of the tube section measured 2.74 inches. If desired, there can be formed on opposite sides of the annular cavity 80 small circular holes 82 which, in the aforementioned embodiment, measure 0.38 inch. These holes 82 are provided for use with a suitable tool to be used to unscrew one tube section from the adjacent tube section 70.

The tube insert 85 is similar to the above described tube insert 52 except that it has no external shoulder formed thereon. The tube insert 85 has a cylindrical exterior surface 86 having a uniform diameter extending substantially the length of the tube insert. The tube section 70 is formed with an internal annular shoulder 88 at the inner end of the enlarged cavity 80 and this annular shoulder is adapted to engage one end 90 of the tube insert 85 mounted in the respective tube section so as to stop the tube insert 85 from moving further along the tube passageway 42 when the liner is assembled for use. It will be appreciated that the axial length L of the tube insert corresponds closely to the distance D₂ in the cavity 80 of its respective tube section. In other words, the tube insert 85 is constructed so that it fits entirely within the non-threaded section of the enlarged cavity 80.

FIGS. 13 to 15 illustrate how the axial bore or passageway 58 can vary in size depending upon the bar stock with which the tube insert is to be used. As in the first embodiment, the passageway or bore has a first portion 60 which tapers inwardly from the end 90 and the passageway also has a second portion 62 of uniform diameter. In the tube insert of FIG. 13, the second portion 62 has a relatively small diameter. In one embodiment of the tube insert 85, this diameter is 0.635 inch while the external diameter of this tube insert is about 2.24 inches. In the tube insert 85′ shown in FIG. 14, the second portion 62′ of the bore has a larger diameter while the external diameter of the tube insert remains the same. In one preferred embodiment, the diameter of the portion 62′ is 0.875 inch while the external diameter is about 2.2 inches and the length is 1.625 inches. It will be appreciated that if the user is provided with the inserts 85 of FIG. 13 and the narrow portion 62 of the bore is too narrow for the bar stock to be worked, it is relatively easy for the user to drill out the axial bore of the tube insert so that the portion 62 has a larger diameter, such as that shown in FIG. 14.

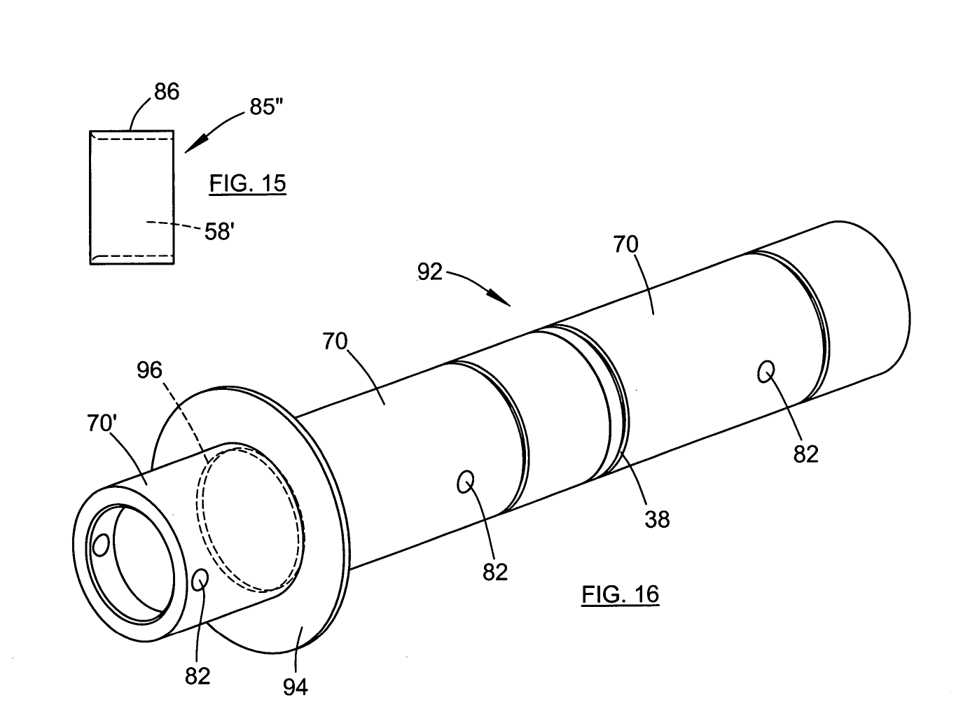

Turning to FIG. 15, this figure shows a tube insert 85″ which has a maximum diameter, axial bore or passageway 58′. Thus, with this tube insert, the axial length and the external diameter are the same as the inserts 85 and 85′ of FIGS. 13 and 14. However, in this embodiment, the diameter of the bore 85′ is much larger. For example, the diameter of the bore 85′ can be 2.01 inches in a tube insert having an external diameter of 2.24 inches. The preferred material for these bushings or tube inserts is nylon.

Turning now to FIG. 16 of the drawings, this drawing illustrates an assembled spindle liner 92 constructed in accordance with the invention. This spindle liner includes a number of the tube sections 70 which can vary in length as shown. Fitted onto this spindle liner is an optional stop flange member 94 which is preferably a flat, disk-shaped member that can be made of the same material as the tube sections or it can be made of a different material such as a suitable metal. The stop flange member is preferably mounted between two tube sections and, in the illustrated embodiment, it is mounted between a regular-sized tube section 70 and short tube section 70′. It will be understood that the preferred flange member 94 shown has a central aperture 96 through which the male connector 44 of the adjacent tube section can be inserted for connection to the adjacent female connector. The stop flange member 94 has an outer diameter greater than the external diameter of the tube sections with which it is used and greater than the width of the feed passageway extending through the draw tube or spindle. The purpose of the stop flange member 94 is to hold the spindle liner in its proper axial position in the draw tube and to prevent the spindle liner from being driven axially towards the chuck by the bar feeder of the lathe system.

It will be appreciated by those skilled in the construction of lathe machines and equipment that various modifications and changes can be made to the described and illustrated spindle liner without departing from the spirit and scope of this invention. For example, it is possible to employ a spindle liner constructed in accordance with the invention in a lathe or automatic lathe that does not employ the usual draw tube in the spindle. In a machine of this type, the spindle liner can be inserted into the passageway formed by the spindle itself in order to support the stock to be worked. All such modifications and changes as fall within the scope of the accompanying claims are intended to be part of this invention.

1. A spindle liner for insertion into a draw tube of a lathe or other turning machine for supporting stock to be worked by the lathe or turning machine, the liner comprising:
a plurality of tube sections each having a principal external diameter selected to permit said tube sections to be placed substantially end-to-end in said draw tube and corresponding closely to an internal diameter of the draw tube, each tube section having a tube passageway extending the length of the tube section, a male connector at one end of the tube section, and a, female connector at an opposite end of the tube section adapted to connect to the male connector of an adjacent tube section; and
a plurality of tube inserts each adapted to be mounted within the tube passageway of a respective one of said tube sections adjacent said opposite end of the respective tube section, each of said tube inserts defining an axial bore therein through which the stock to be worked can pass in a close fitting manner,
wherein, during use of said liner, said tube inserts are kept in a desired spaced apart relationship by the tube sections.

2. A liner according to claim 1 wherein said male connector is externally threaded and has an outer diameter that is smaller than said principal external diameter, and said female connector is internally threaded with threads matching the threads on said male connector.

3. A liner according to claim 2 including at least one annular groove formed around each tube section and an O-ring made of resilient, flexible sealing material mounted in each annular groove and projecting therefrom.

4. A liner according to claim 1 including two annular grooves formed around each tube section near opposite ends of the respective tube section and an O-ring made of resilient, flexible sealing material mounted in each annular groove and projecting therefrom.

5. A liner according to claim 1 wherein each tube insert has first and second axially extending sections with the first section having a smaller external diameter than said second section, an external annular shoulder is formed on each tube insert between its first and second axially extending sections, and each tube section is formed with an internal annular shoulder located near said female connector of the respective tube section and adapted to engage said external annular shoulder of the tube insert mounted in the respective tube section so as to stop the tube insert from moving further along the tube passageway when said liner is assembled for use.

6. A liner according to claim 5 wherein said first section of each tube insert forms a first portion of said bore and said first portion tapers inwardly from one end of the tube insert over the axial length of said first section.

7. A liner according to claim 1 wherein both said tube sections and said tube inserts are made of a strong, rigid plastics material.

8. A liner according to claim 2 wherein both said tube sections and said tube inserts are made of nylon.

9. A liner according to claim 2 wherein said tube sections are substantially identical to each other and each has a length in the range of 6 to 10 inches.

10. A liner according to claim 1 wherein each tube insert has a cylindrical exterior surface having a uniform diameter extending substantially the length of the tube insert and each tube section is formed with an internal annular shoulder adapted to engage one end of the tube insert mounted in the respective tube section so as to stop the tube insert from moving further along the tube passageway when the liner is assembled for use.

11. A liner according to claim 10 wherein said male connector is externally threaded and has an outer diameter that is smaller than said principal external diameter, and said female connector is internally threaded with threads matching the threads on said male connector.

12. A liner according to claim 11 including at least one annular groove formed around each tube section and an O-ring made of resilient, flexible sealing material mounted in each annular groove and projecting therefrom.

13. A spindle liner for mounting inside a spindle of a lathe or turning machine for supporting stock to be worked by the lathe or turning machine, the liner comprising:
a plurality of tube sections each having a main longitudinal portion with a selected external diameter suitable for insertion of each tube section into a feed passageway provided in said spindle so as to permit said tube sections to be placed substantially end-to-end in said spindle, each tube section defining a tube passageway extending the length of the tube section, said tube sections including connectors for joining said tube sections together in a substantially end-to-end manner; and
a plurality of tube inserts each adapted to be mounted within said tube passageway of a respective one of said tube sections, each tube insert defining an axial insert passageway therein through which the stock to be worked can pass in a close fitting manner,
wherein, during use of said liner, said tube inserts are kept in a desired spaced apart relationship by the tube sections.

14. A spindle liner according to claim 13 wherein said connectors include male and female integral connecting sections at opposite ends of each tube section, said male connecting section being externally threaded and said female connecting section being internally threaded with threads matching the threads of the male connecting section.

15. A spindle liner according to claim 13 wherein the axial insert passageway of each tube insert has first and second axially extending portions, said first portion of said axial insert passageway tapers inwardly from one end of the tube insert to said second portion, and said second portion has a substantially uniform cross-section along its axial length and transverse dimensions corresponding closely to transverse dimensions of said stock to be worked.

16. A spindle liner according to claim 13 wherein each tube section has at least one annular groove extending around an exterior cylindrical surface thereof and an O-ring made of resilient, flexible sealing material is mounted in said at least one annular groove.

17. A spindle liner according to claim 14 including two annular grooves formed around each tube section near opposite ends of the respective tube section and an O-ring made of resilient, flexible sealing material mounted in each annular groove and projecting therefrom.

18. A spindle liner according to claim 13 wherein each tube insert has first and second axially extending sections with the first section having a smaller external diameter than said second section, an external annular shoulder is formed on each tube insert between its first and second axially extending sections, and each tube section is formed with an internal annular shoulder adapted to engage said external annular shoulder of the tube insert mounted in the respective tube section so as prevent any significant movement of the tube insert along said tube passageway when said liner is assembled and ready to use.

19. A spindle liner according to claim 15 wherein both said tube sections and said tube inserts are molded and are made of a strong, rigid plastics material.

20. A spindle liner according to claim 16 wherein both said tube sections and said tube inserts are molded and are made of nylon.

21. A spindle liner according to claim 14 wherein said tube sections are substantially the same as each other and each has a length in the range of 6 to 10 inches.

22. A spindle liner according to claim 13 wherein each tube insert has a cylindrical exterior surface having a uniform diameter extending substantially the length of the tube insert and each tube section is formed with an internal annular shoulder adapted to engage one end of the tube insert mounted in the respective tube section so as to stop the tube insert from moving further along the tube passageway when the liner is assembled for use.

23. A spindle liner according to claim 22 wherein said connectors include male and female integral connecting sections at opposite ends of each tube section, said male connecting section being externally threaded and said female connecting section being internally threaded with threads matching the threads of the male connecting section.

24. A spindle liner according to claim 22 wherein each tube section has at least one annular groove extending around an exterior cylindrical surface thereof and an O-ring made of resilient, flexible sealing material is mounted in said at least one annular groove.

25. A spindle liner for use in a lathe system for supporting bar stock to be worked by the lathe system, the liner comprising:
a plurality of tube sections each having a substantially cylindrical main section with a selected external diameter suitable for insertion of each tube section into a feed passageway for said bar stock provided in said lathe system and a first integral connector projecting axially from one end of said cylindrical section, the opposite end of said cylindrical section having a second connector so as to be detachably connectible to the first connector of an adjacent one of said tube sections, each tube section having a tube passageway extending the length of the cylindrical section and the first connector; and
a plurality of tube inserts each adapted to be mounted within the tube passageway of a respective one of said tube sections, each of said tube inserts forming a central, axial insert passageway through which the bar stock to be worked can pass in a close fitting manner,
wherein said spindle liner includes means for maintaining said tube inserts in a desired spaced-apart relationship relative to one another when said spindle liner is assembled and ready for use in the lathe system.

26. A spindle liner according to claim 25 wherein said first integral connector has external threads and said second connector comprises internal threads formed within said cylindrical main section.

27. A spindle liner according to claim 25 including at least one annular groove formed around said cylindrical main section and an O-ring made of resilient, flexible rubber or rubberlike material mounted in each annular groove and projecting therefrom.

28. A spindle liner according to claim 27 wherein each tube insert has first and second axially extending sections with the first section having a smaller external diameter than said second section, an external annular shoulder is formed on each tube insert between its first and second axially extending sections, and each tube section is formed with an internal annular shoulder located near said second connector of the respective tube section and adapted to engage said external annular shoulder of the tube insert mounted in the respective tube section, said external and internal annular shoulders providing at least one part of said maintaining means.

29. A spindle liner according to claim 25 wherein each axial insert passageway has a first portion and a second portion and said first portion of the insert passageway tapers inwardly from one end of the tube insert to said second portion through which the bar stock to be worked can pass in a close fitting manner.

30. A spindle liner according to claim 26 wherein both said tube sections and said tube inserts are made of nylon.

31. A spindle liner according to claim 25 wherein each tube has a cylindrical exterior surface having a uniform diameter extending substantially the length of the tube insert and each tube section is formed with an internal annular shoulder adapted to engage one end of the tube insert mounted in the respective tube section so as to stop the tube inset from moving further along the tube passageway when the liner is assembled for use.

32. A spindle linear according to claim 25 including a stop flange member adapted for connection to the spindle liner when the liner is assembled, said stop flange member being flat and having an outer diameter greater than said selected external diameter of each tube section.

33. A spindle liner according to claim 26 including a flat, disc-shaped, stop flange member having a central aperture and adapted for insertion between two of said tube sections near one end of the assembled spindle liner, said stop flange member having an outer diameter greater than said selected external diameter of each tube section and greater than the width of the feed passageway.
